(19) United States
(12) Patent Application Publication
(10) Pub. No.: US 2004/0015565 A1
(43) Pub. Date: Jan. 22, 2004

(54) Software executable module for acting as a web-based content bridge

(76) Inventors: Mike Bednar, Wadsworth, OH (US); Phil Bookman, Los Gatos, CA (US); Jeff Browne, Lewis Center, OH (US); Leonard Greenberg, Bexley, OH (US); Joe Keller, Sunbury, OH (US)

Correspondence Address: Patrick P. Phillips, Kremblas, Foster, Phillips & Pollick, 7632 Slate Ridge Boulevard, Reynoldsburg, OH, 43068, US

(21) Appl. No.: 10/199,683

(22) Filed: Jul. 22, 2002

(51) Int. Cl. G06F 15/16

(52) U.S. Cl. 709/219; 709/218; 709/231

(57) ABSTRACT

A software executable module is provided which is connected to a local web server located within a learning management system installation where the web server facilitates the transmission of content requests and responses, and tracking information to and from a user of the learning management system, with the content requests and responses including ones to and from the learning management system server as well as ones to and from a remote content server, with the module acting as a filter for the local web server to stream remote content from the remote content server through the local web server, making the tracking information and the remote content responses appear to the browser of the learning management system to be from the same domain. A method is provided for simultaneously utilizing a local and a remote server having different domains. In a specific environment, namely, in a learning management system installation, a method of launching and tracking content from a remote content server is provided.

### BACKGROUND OF THE INVENTION

1. Field of the Invention

The present invention relates generally to a generic solution to the cross-frame or cross-domain security problem encountered by a company when it wants its browser to launch and to track content located at an external content server, where the company and the content server utilize different second-level domain names, and more particularly to a software executable module for acting as a web server filter, and still more particularly to such a module utilized as part of a learning management system (LMS).

2. Description of Related Art

Increasingly, employers are providing opportunities for continuing education for their employees. The type of continuing education being provided may be nothing more than technical support or updates on new products or services, but it can include courses required for employee certification, courses to boost employee productivity and bolster well-being, as well as courses designed to assess the skills of the particular employee to maximize their benefit as an employee.

However, it is often not enough to just provide such educational opportunities. Companies who provide these opportunities more often than not find that they need to manage this educational component. In order to do this, records must be created and tracked during and after the completion of each learning experience. These records can track, among other things, the course taken, the specific starting and ending points associated with each learning session, and an assessment of the degree to which the employee has learned the material.

To assist companies with the providing of such educational opportunities, an entire industry has been created which focuses on learning management systems (“LMS”). Historically, the LMS of a company enabled an employee to obtain education in a classroom environment, in a virtual classroom environment, or via computer either online or through the use of a compact disc (“cd”). However, it must be appreciated that typically these modes of education were all internal. In other words, in the case of cds, the company could purchase these educational resources, store these resources at the company, and then make these resources available to employees of the company at a company site, either physically in a seminar room or at an employee workstation via the company's intranet system. As far as maintaining records of employees' use of these educational resources, such records were internally created and stored on the company's server. Ideally, the company's LMS permitted optimal tracking of the employee's educational endeavors.

Over time, some entities realized the potential market for these type of educational resources, leading to their developing such products. Moreover, these companies began to specialize in providing access via their content server to these products for employees of companies. This licensing to a web site enabled there to be more timely updating of the licensed material, made it easier for such content vendors to completely cease serving non-paying client companies, and eliminated companies having to be responsible for physically storing and maintaining a growing library of courses. However, the development of these products in conjunction with their ability to be accessed at a content server external to the company of the employee being trained resulted in problems from the standpoint of companies with existing LMS systems.

One situation in which problems arose concerned companies that provided access for their employees to this type of educational opportunity through use of what is known as a proxy server, with the proxy server being located at the company. Under this scenario, individual computer terminals at the company would each be connected to the company's proxy server, with the proxy server facilitating online contact with an external content server located at the educational provider. Proxy servers have been used to provide access to the Internet due to monitoring considerations and bandwidth considerations.

However, under this scenario, there is no way for the company to be able internally to keep accurate track of the training through its LMS. Moreover, proxy servers do not address the bigger issue of cross-domain security, which problem will be discussed more fully below. Consequently, if an LMS utilizes a proxy server, the content is preserved as coming from a domain other than that which is associated with the LMS, and the company cannot also track online the learning content. While records could be generated subsequent to the employee utilizing the proxy server, the records would have to be individually entered by someone at the company under what would amount to be an honor system. Otherwise, there would be no way to really know what transpired. This option consumes employee resources, too readily permits the introduction of clerical error, raises the potential for abuse, and perhaps most importantly fails to address the real problem as it concerns cross-domain security. Therefore, since proxy servers have nothing to do with the problem of cross-domain security, LMS providers have not viewed the use of a proxy server as even a potential solution to the cross-domain security problem.

A few educational providers, also known as content vendors, have attempted to address this problem of tracking through the development of special software installed on the external content server. In one such system, tracking data is communicated by the content vendor directly onto its content server. This data is later sent from the remote content server to the company's LMS server. However, this alleged solution to the problem creates a situation which requires the company to permit exposure of its LMS server outside the company's firewall. This situation is unacceptable to many companies, due to the potential risks associated with such exposure.

While the company itself could develop special software, and request a content vendor to install the company's software on the content vendor's content server, individual content vendors would have to have such special software installed from each of the companies using the services of the content vendor in order to lessen companies' firewall concerns. Even then, this approach to the problem is cumbersome, and would limit a company's choice of educational options to only those content vendors which had permitted the installation of such special software.

Still another problem arose in connection with companies that had an LMS in place, where employees wanted to access educational opportunities provided by content vendors at a remote content server. Although an employee not connected to a company's LMS could access content externally, for example via the Internet, this would not permit tracking. Consequently in theory, all that needed to be done was to have the employee access the external content while being simultaneously connected to the company's LMS server. However, when the employee attempted to launch the course by opening the course start URL, the browser associated with the LMS server would inform the employee that access or permission was denied.

The reason for this problem has to do with security restrictions built into the company's browser, and more particularly with a situation known as cross-frame or cross-domain security. Cross-frame security utilizes the concept of a “security context” to make decisions as to cross-frame scripting. Security context takes into account the domain, protocol, and zone of Internet documents. Any differences in these three between the document containing the script and a document in a different frame that the script is trying to manipulate causes this type of security violation. Therefore, cross-frame security prevents an object or script in one frame from being able to access objects or scripts in another frame when there are two different second level domains involved, such as is the case with a company's LMS server and a content vendor's external content server. Although in most cases the security concern is valid, in the case of trying to track content from an external content server, the problem frustrates the attainment of the educational goal.

This problem has been recognized by several companies, and at least one company, Microsoft®, has recently proposed a solution to the problem. This proposed solution requires that for interaction to occur, each document.domain property must be set to a shared second-level domain. Under the Microsoft® proposal, the document.domain=“microsoft.com”, which is fine as long as the browser being used is Microsoft's, and the document being accessed also has the same major domain. Thus, the so-called Microsoft® solution does not even address the real problem encountered by companies and LMS providers which is the cross-domain security problem.

However, there are two problems with this proposed solution to the problem of cross-frame security. First, the solution is not generic to all browsers. As mentioned above, Microsoft's solution only works if there is a Microsoft® browser involved. Second, if the solution is applied to other domains, it only works if the systems have the same major domain, i.e. the first-level domain names must be the same. In other words, the solution is only an intranet solution. By way of example, the proposed document.domain workaround would not work as between microsoft.com and netscape.com, but could work for www.netscape.com and content.netscape.com.

It is thus apparent that the need exists for a generic solution to the cross-frame security problem encountered by a company when it wants its browser to launch and to track content located at an external content server, where the company and the content server utilize different second-level domain names.

### BRIEF SUMMARY OF THE INVENTION

There is disclosed in a learning management system installation, a method of launching and tracking content from a remote content server. The method includes the steps of transmitting information of a user of the learning management system to and from the learning management system server, transmitting content requests of a user of the learning management system to a remote content server, receiving content responses from the remote content server at a module of a web server of the learning management system, streaming the content responses through the web server to make the content responses appear to the browser of the learning management system to be from the same domain as the information transmitted to and from the learning management system server, and transmitting the content responses to the user of the learning management system.

The information, content requests to a remote content server, and content responses from the remote content server all are transmitted through the web server of the learning management system. The information facilitates tracking of the user of the content responses from the remote content server. The tracking includes the creation and updating of training records, with the records indicating what has been viewed by the user, when such viewing occurred, and how well the user grasped the material contained in the content responses.

The module is a software executable module which is implemented as a web server filter. The method includes the additional step of retrieving the content responses on behalf of the browser of the learning management system. The method includes the additional step of displaying the content responses for the user.

There is also disclosed a software executable module connected to a local web server located within a learning management system installation where the web server facilitates the transmission of content requests and responses, and tracking information to and from a user of the learning management system, with the content requests and responses including ones to and from the learning management system server as well as ones to and from a remote content server, with the module acting as a filter for the local web server to stream remote content from the remote content server through the local web server, making the tracking information and the remote content responses appear to the browser of the learning management system to be from the same domain.

The module is in the form of a file installed on the web server. The module, when it encounters a request from the learning management system for content from a remote content server, recognizes the request as coming from the learning management system, distinguishes the request as being for content from a remote content server, and asks for the content, which content when received by the module is forwarded to the user of the learning management system, with the module causing the content forwarded as a response from the web server to be in the domain of the learning management system.

There is further disclosed a method for simultaneously utilizing a local and a remote server having different domains, with the method including the steps of transmitting information of a user of the local system to and from the local system server, transmitting content requests of the user to a remote content server, receiving content responses from the remote content server at a module of a web server of the local system, streaming the content responses through the web server to make the content responses appear to the browser of the local system to be from the same domain as the information transmitted to and from the local system server, and transmitting the content responses to the user of the local system.

The information, content requests to a remote content server, and content responses from the remote content server all are transmitted through the web server of the local system. In one embodiment of the invention, the information includes the creation and updating of training records, with the records indicating what has been viewed by the user, when such viewing occurred, and how well the user grasped the material contained in the content responses.

The module used in this method for simultaneously utilizing a local and a remote server having different domains, is a software executable module which acts as a web server filter. The method includes the additional step of retrieving the content responses on behalf of the browser of the local system. The method also includes the additional step of displaying the content responses for the user.

One objective of this invention is to provide in a learning management system installation, a method of launching and tracking content from a remote content server.

Another objective of this invention is to provide a software executable module connected to a local web server located within a learning management system installation whereby the web server facilitates the transmission of content requests and responses, and tracking information to and from a user of the learning management system, with the content requests and responses including ones to and from the learning management system server as well as ones to and from a remote content server. An important aspect of this objective is the module making the tracking information and the remote content responses appear to the browser of the learning management system to be from the same domain.

Yet another objective of this invention is to provide a method for simultaneously utilizing a local and a remote server having different domains, with the method including the steps of transmitting information of a user of the local system to and from the local system server, transmitting content requests of the user to a remote content server, receiving content responses from the remote content server such that the content responses appear to the browser of the local system to be from the same domain as the information transmitted to and from the local system server. An aspect of this invention is the providing of a software executable module which acts as a web server filter.

Other aspects and advantages of the instant invention will be appreciated from the following description, drawings, and the appended claims.

### BRIEF DESCRIPTION OF THE DRAWINGS

FIG. 1 discloses a schematic diagram illustrating an environment in which the present invention may be applied.

### DETAILED DESCRIPTION OF THE INVENTION

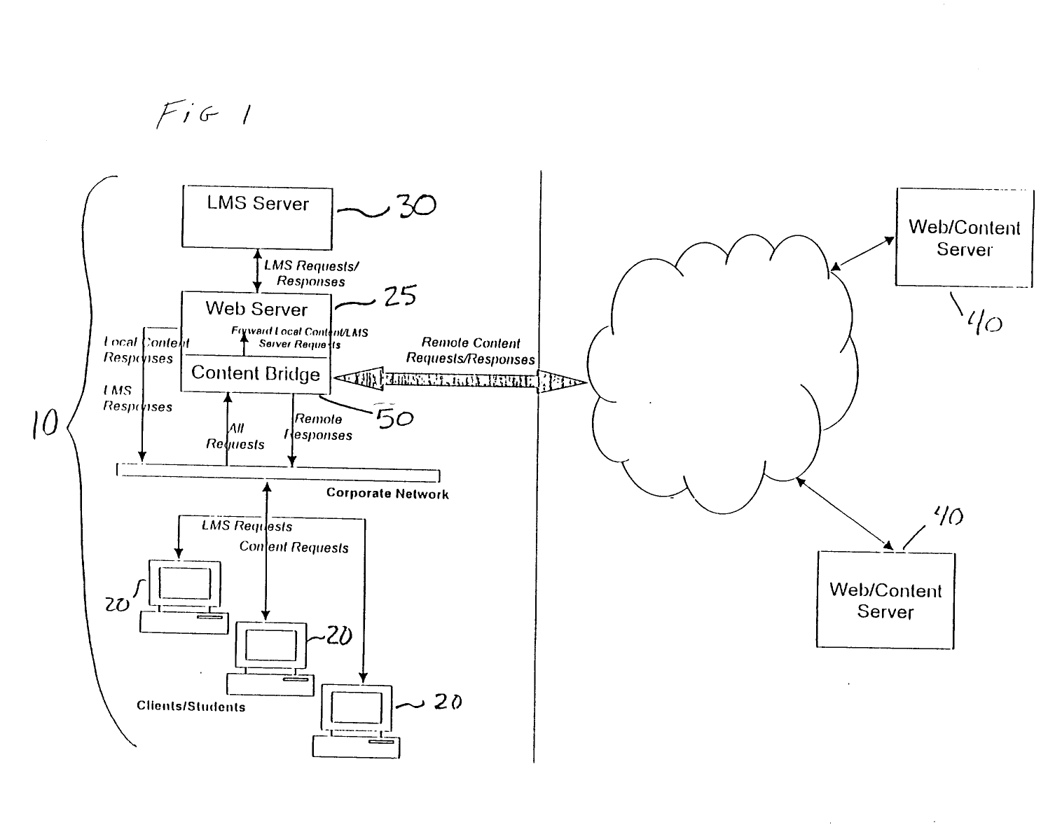

Having reference to the drawings, attention is directed first to FIG. 1 which shows a schematic diagram of a learning management system installation (“LMS”) as part of a corporate network in accordance with one embodiment of the present invention, with the LMS installation being designated generally by the numeral 10. LMSs are fairly well known in corporate settings, and comprise individual computers 20, a web server 25, and an LMS server 30.

Historically, where an LMS has been utilized, it has been in connection with internal tracking of educational offerings. For example, a user at a computer 20 would request content be supplied to the user from the web server 25, with tracking of the endeavor being facilitated by the LMS server 30. However, as has been discussed above, a problem with LMSs exists where content is attempted to be accessed from a remote content server 40. Whereas the user is on a local network, the content server being on a different network consequently has a different Internet domain. In this type of situation, heretofore the content could not be launched from the remote content server yet tracked by the LMS.

In accordance with the invention, a software executable module 50 is provided. This module 50 has been given the name, “content bridge”. The term “content bridge” describes a technique and software module developed to access and track online, content (such as self-paced learning content) even when the content is installed on a different domain. Utilization of a content bridge has particular application at this time in allowing a Learning Management System (LMS) to access and track online self-paced learning content, where the content is installed on a differenct domanin thatn the LMS itself.

This module 50 hooks into the local web server 25. Once there, it acts on behalf of the browser used by the LMS to stream any remote content through the local web server 25 to the user's browser, thus making the LMS scripting code and the content appear to be from the same web domain.

The module 50 is installed on the local web server 25 and acts as a filter. Every request the web server receives for content passes first through the content bridge 50. If the request is for local content, the content bridge allows the request to proceed to the local web server where the local content response is sent back to the user's computer 20. However, if the content bridge 50 encounters a request for content from a remote content server, the software executable module distinguishes between a request which will utilize tracking and one which will not. If the request will not utilize tracking, the LMS will not need to be involved. In such case, the Internet can be accessed as in the prior art.

However, if the request will utilize tracking and hence involve the LMS, the content bridge intercepts this request for remote content and asks for the content. The content bridge thus retrieves the content responses on behalf of the browser of the local system. As the content is received, the content bridge sends it to the user, with this transmission indicating that the content is coming from the same domain as the LMS code associated with tracking. Thus the method associated with the invention permits the displaying of the content responses for the user.

In actual use, an additional checkbox is present in the ID Data for a Content Object. This checkbox allows the LMS installation for example to turn on this feature for the content in question. No changes to the Content Object's start URL are necessary in order to make use of the invention.

The solution to the long-standing problem thus overcome by use of this invention is believed to be generic, thus making it compatible with most if not all content vendors. Any content certified to work in the LMS when installed locally would work is when accessed via the Internet. Some of the obvious advantages associated with the invention include: (1) the fact that it does not require any extensive custom programming; (2) it does not require content vendors to install special software on their servers so that each of their clients can access a version of the content specific to only that client; (3) it does not require the user to have the LMS server outside the firewall, since the server on which the module runs only needs to have access to the Internet like a typical workstation with web browser; and (4) it does not require content to be installed locally on the user's servers. One key aspect associated with this last advantage is allowing the content to be updated on the content server without having to reinstall it on the user's server.

By the user no longer being limited to launch and track content installed only locally at the user's site, the content server can be located anywhere. Plus, a user can use the content, while still storing the tracking data in the form of training records in the user's own LMS database in LMS server 30.

While the content bridge of this invention, the method of launching and tracking content from a remote content server in a learning management system installation, and the method for simultaneously utilizing a local and a remote server having different domains herein described constitutes one embodiment of the invention as shown, it is to be understood that the invention is not limited to the precise environment as shown, and that changes may be made therein without departing from the scope of the invention which is defined in the appended claims. Persons skilled in the art will recognize from the foregoing detailed description that other modifications or embodiments are possible for use in the same or different environments.

What is claimed is:

1. In a learning management system installation, a method of launching and tracking content from a remote content server, comprising the steps of
transmitting information of a user of the learning management system to and from the learning management system server,
transmitting content requests of a user of the learning management system to a remote content server,
receiving content responses from said remote content server at a module of a web server of the learning management system,
streaming said content responses through said web server to make said content responses appear to the browser of the learning management system to be from the same domain as the information transmitted to and from the learning management system server, and
transmitting said content responses to the user of the learning management system.

2. The method of claim 1 wherein said information is transmitted through a web server of the learning management system.

3. The method of claim 1 wherein said information, content requests to a remote content server, and content responses from the remote content server all are transmitted through said web server of the learning management system.

4. The method of claim 1 wherein said information facilitates tracking.

5. The method of claim 4 wherein said tracking includes the creation and updating of training records, said records indicating what has been viewed by the user, when such viewing occurred, and how well the user grasped the material contained in the content responses.

6. The method of claim 1 wherein said module is a software executable module which acts as a web server filter.

7. The method of claim 6 which includes the additional step of retrieving said content responses on behalf of the browser of the learning management system.

8. The method of claim 1 which includes the additional step of displaying said content responses for the user.

9. The method of claim 8 which includes the additional step of displaying said content responses for the user.

10. A software executable module connected to a local web server located within a learning management system installation where the web server facilitates the transmission of content requests and responses, and tracking information to and from a user of the learning management system, with the content requests and responses including ones to and from the learning management system server as well as ones to and from a remote content server, said module acting as a filter for the local web server to stream remote content from the remote content server through the local web server, making the tracking information and the remote content responses appear to the browser of the learning management system to be from the same domain.

11. The device of claim 10 wherein said module is a file installed on the web server.

12. The device of claim 10 wherein said module when it encounters a request from the learning management system for content from a remote content server, recognizes the request as coming from the learning management system, distinguishes the request as being for content from a remote content server, and asks for the content, which content when received by said module is forwarded to the user of the learning management system, said module causing the content forwarded as a response from the web server to be in the domain of the learning management system.

13. A method for simultaneously utilizing a local and a remote server having different domains, comprising the steps of
transmitting information of a user of the local system to and from the local system server,
transmitting content requests of the user to a remote content server,
receiving content responses from said remote content server at a module of a web server of the local system,
streaming said content responses through said web server to make said content responses appear to the browser of the local system to be from the same domain as the information transmitted to and from the local system server, and
transmitting said content responses to the user of the local system.

14. The method of claim 13 wherein said information is transmitted through a web server of the local system.

15. The method of claim 14 wherein said information, content requests to a remote content server, and content responses from the remote server all are transmitted through said web server of the local system.

16. The method of claim 13 wherein said information includes the creation and updating of training records, said records indicating what has been viewed by the user, when such viewing occurred, and how well the user grasped the material contained in the content responses.

17. The method of claim 13 wherein said module is a software executable module which acts as a web server filter.

18. The method of claim 13 which includes the additional step of retrieving said content responses on behalf of the browser of the local system.

19. The method of claim 13 which includes the additional step of displaying said content responses for the user.

20. The method of claim 18 which includes the additional step of displaying said content responses for the user.
